(19) United States
(12) Patent Application Publication
(10) Pub. No.: US 2001/0029676 A1
(43) Pub. Date: Oct. 18, 2001

(54) EZ measure fish tape

(76) Inventors: Lance Allen Biglin, Crestline, OH (US); Kevin Lee Daniels, Fredericktown, OH (US); Jeffrey Lynn Doup, Butler, OH (US)

Correspondence Address: LANCE ALLEN BIGLIN, 7833 STATE ROUTE 96, CRESTLINE, OH, 44827, US

(21) Appl. No.: 09/753,956

(22) Filed: Jan. 4, 2001

Related U.S. Application Data
(60) Provisional application No. 60/182,496, filed on Feb. 15, 2000.

(51) Int. Cl. G01B 3/04; B43L 7/00

(52) U.S. Cl. 33/511; 33/494; 33/549

(57) ABSTRACT

A fish tape with one-foot increments affixed to its surface using a laser. This will allow an electrician to guide the fish tape through the raceway only one time because the length of the raceway will be indicated by the one-foot increments on the fish tape and therefore eliminate many steps that electricians must currently perform because of the prior art.

### BACKGROUND OF THE INVENTION

This invention relates to an electrician's fish tape that is used to pull electrical conductors through a raceway. The fish tape is a long piece of flat spring steel approximately two hundred feet long. The fish tape is guided through the beginning of the raceway completely through to the end of the raceway. The prior art makes the electrician mark the fish tape using tape or some other material so the length of the raceway may be determined once the fish tape is pulled back through the raceway. The electrician then pulls the fish tape out of the raceway and manually measures the length of the fish tape from the hook end to the mark made by the electrician on the fish tape with a tape measure. After the measurement is completed, the electrical conductors must be cut to the measured length. The fish tape is re-inserted and guided through the entire length of the raceway. Finally, the electrician must fasten the electrical conductors to the hook end of the fish tape so the electrical conductors can be pulled back through the raceway. This process consumes a vast amount of time.

References Cited: 1,020,672 Mar. 19, 1912 Wilson

### BRIEF SUMMARY OF THE INVENTION

To drastically increase the efficiency for the electrician over the prior art, extend the fish tape until it is extended to its full length. The fish tape is then measured marking each foot of the fish tape. Using a laser, the one-foot increments are affixed to the surface of the fish tape. This process only needs to be done once and the invention is complete.

As was explained earlier, the prior art makes the electrician manually mark the fish tape with tape or some other material. The electrician must pull the fish tape back through the raceway and measure the fish tape using a tape measure. The next step is to re-insert the fish tape into the raceway and guide the fish tape through the entire length of the raceway. Finally, the electrician fastens the measured and cut electrical conductors to the hook end of the fish tape and pulls the electrical conductors back through the raceway. The present invention eliminates these steps. The invention allows the electrician to guide the fish tape through the beginning of the raceway completely through to the end of the raceway. Next, the electrician reads the one-foot increments on the fish tape to determine the length of the raceway. Then, the electrician cuts the electrical conductors to the desired length without pulling the fish tape back out of the raceway. Finally, the electrician will connect the electrical conductors to the hook end of the fish tape and pull the electrical conductors back through the raceway. The amount of time saved by eliminating the steps above is immense and drastically increases efficiency for the electrician.

### BRIEF DESCRIPTION OF THE DRAWINGS

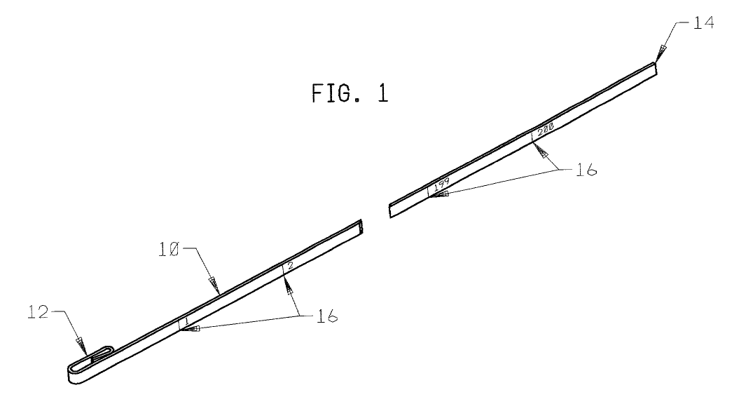

The invention will be further described in connection with the accompanying drawing, in which: FIG. 1 is a perspective view of the fish tape with the one-foot increments affixed to its surface.

### REFERENCE NUMERALS IN DRAWING

10 Fish Tape

12 Hook

14 Flat End

16 One-foot Increments

### DETAILED DESCRIPTION

A fish tape indicated generally by reference numeral 10. The fish tape 10 is made from spring steel. One end of the fish tape 10 is bent to form a hook 12. At the opposite end of the fish tape 10 there is a flat end 14. Beginning with the hook 12 and including the length of the hook 12, measure a one-foot increment 16 and then continue to measure one-foot increments 16 starting at the end of the preceding one-foot increment 16 until the flat end 14 of the fish tape 10 is reached. Smaller or larger increments than the one-foot increments 16 can be used but the preferred embodiment is the one-foot increments 16. The one-foot increments 16 are affixed to the surface of the fish tape 10 using a laser to allow for convenient measuring of the electrical conductors. The one-foot increments 16 could be affixed to the surface of the fish tape 10 using acid etching or stamping but the preferred embodiment is to bum the one-foot increments 16 on to the fish tape 10 using a laser. While the foregoing invention has been shown and described with respect to the preferred embodiment, it will be understood by those of skill in the art that various changes in form and detail may be made therein without departing from the spirit and scope of the claimed invention.

I claim:

1. A fish tape with units of measurement affixed to its surface comprising:
(a) extend a fish tape to its entire length
(b) measure said fish tape to determine one-foot increments
(c) affix said one-foot increments on to said fish tape with a laser.
